(19) United States
(12) Patent Application Publication
(10) Pub. No.: US 2014/0271970 A1
(43) Pub. Date: Sep. 18, 2014

(54) MODULAR SUPERCRITICAL FLUID MATERIALS PROCESSING SYSTEM

(71) Applicant: nanoScience Engineering Corporation, (US)

(72) Inventors: Roy G. Crawford, Detroit, MI (US); Pranav Nawani, Farmington Hills, MI (US); David E. Burnett, Birmingham, MI (US); James Braddock, JR., Romulus, MI (US)

(73) Assignee: nanoScience Engineering Corporation, West Bloomfield, MI (US)

(21) Appl. No.: 13/834,992

(22) Filed: Mar. 15, 2013

(51) Int. Cl. B01F 13/02; B29C 47/00

(52) U.S. Cl. CPC B01F 13/02; B29C 47/0038
USPC 425/377; 366/101; 425/380

(57) ABSTRACT

A modular system for processing an exfoliated aggregate material or a polymer composite material comprising the exfoliated aggregate, utilizing supercritical fluid processing is described. The modular system may provide exfoliated aggregate particulates, polymer composite materials or master batch polymer composite materials.

### TECHNICAL FIELD

The present disclosure is related to modular system for producing an exfoliated aggregate material and polymer composite materials including the exfoliated aggregate material. The modular system utilizes a supercritical fluid processing method to produce the exfoliated aggregate material or polymer composite material.

### BACKGROUND

The use of plastics in various industries has been steadily increasing due to their light weight and continual improvements to their properties. For example, in the automotive industry, polymer-based materials may comprise a significant portion, e.g., at least 15 percent, of a given vehicle's weight. These materials are used in various automotive components, such as, interior and exterior trim and side panels. As the industry seeks to improve fuel economy, more steel and aluminum parts, such as fuel containers, etc., may be targeted for replacement by polymer-based materials.

For example, improvements in the physical properties of polymers are desired in order to meet more stringent performance requirements. Such physical properties include toughness, strength, stiffness, dimensional stability, modulus, heat deflection temperature, thermal properties, barrier properties, and rust and dent resistance. Improved physical properties may reduce manufacturing costs by reducing the part thickness and weight of the manufactured part and the manufacturing time thereof. For example, reducing weight of an automobile results in higher mileage and reducing the weight of packaging material can save on transportation costs, etc.

There are a number of ways to improve the properties of a polymer, including reinforcement with particulate fillers or glass fibers. It is known that polymers reinforced with nanometer-sized platelets or particles of layered silicates or clay can significantly improve the mechanical properties at much lower loading than conventional fillers. (See U.S. Pat. No. 6,469,073 issued to Manke et al. (2002).) This type of composite is termed a “nanocomposite.” More specifically, polymer-silicate nanocomposites are compositions in which nano-sized particles of a layered silicate, e.g., organically modified montmorillonite clay(s), are dispersed into a thermoplastic or a thermoset matrix. The improvement in mechanical and other physical properties of nanocomposites is believed to be due to factors such as the increased polymer matrix and nanofiller interaction resulting from higher surface area or aspect ratio of the filler particles.

In its natural state, clay is made up of stacks of individual sheets held together by ionic forces between the basal charge and the ions present within the layers of the clay. The spacing between the layers is in the order of about 1 nanometer (nm) which is smaller than the radius of gyration of typical polymers. Consequently, there is a large entropic barrier that inhibits the polymer from penetrating this gap and intermixing with the clay. Organically treated clays have been achieved by performing intercalation chemistry to exchange a naturally occurring inorganic cation with a bulky organic cation, such as a surfactant.

Near-critical fluids (see U.S. Pat. No. 5,877,005 to Castor et al.) supercritical fluids have been proposed as candidate media for polymerization processes, polymer purification and fractionation, and as environmentally preferable solvents for coating applications and powder formation. (F. C. Kirby, M. A. McHugh, Chem. Rev., 99, 565-602, (1999).) Moreover, supercritical carbon dioxide has been used as a processing aid in the fabrication of composite materials. (T. C. Caskey, A. S. Zerda, A. J. Lesser, ANTEC, 2003, 2250-2254 (2000).) Generally, any gaseous or liquid compound becomes supercritical when compressed to a pressure higher than its critical pressure (Pc) above its critical temperature (Tc). One of the unique characteristics which distinguish supercritical fluids from ordinary liquids and gases is that some properties are tunable simply by changing the pressure and temperature. For example, while maintaining liquid characteristic densities constant, supercritical fluids generally experience faster diffusivity and lower viscosity than a liquid.

Supercritical fluids have been used for delaminating layered silicate materials. (See U.S. Pat. No. 6,469,073 issued to Manke et al. (2002) and U.S. Patent Application Publication No. US 2002/0082331 A1 to Mielewski et al. (2002)). For example, in U.S. Pat. No. 6,469,073, original layered clay structures are swelled or intercalated with supercritical fluid medium to increase the spacing and weakening the bonds between the layers. Upon depressurization, the drastic volume change of the fluid mechanically spreads the layers pushing them apart. The depressurization results in the delaminated structure.

Problems exist when utilizing supercritical processing systems on industrial scale, which have limited the utility of this approach. Thus, there is a need for improved methods and systems for applying supercritical processing methods to produce articles of manufacture on the industrial scale.

### SUMMARY

The present disclosure provides a modular supercritical fluid processing system suitable for production of exfoliated aggregates and polymer nanocomposite materials on large industrial scale.

According to a first embodiments, the present disclosure provides a modular materials processing system comprising a first pressure module comprising at least one supercritical fluid processing vessel having a mechanical mixing device capable of fluidizing an aggregate material and a supercritical fluid and forming a mixture of the supercritical fluid and the aggregate material wherein a portion of the supercritical fluid is dispersed into gallery spaces of the aggregate material; an intermediate pressure release valve configured to release the mixture of the supercritical fluid and the aggregate material from the supercritical fluid processing vessel at sonic velocity and produce a depressurized supercritical fluid and a dispersed, exfoliated aggregate material; and a second module comprising at least one collection vessel configured to collect the depressurized supercritical fluid and the dispersed, exfoliated aggregate material, the collection vessel being in fluid communication with the supercritical fluid processing vessel through the intermediate pressure release valve. In other embodiments, the modular materials processing system may comprise a polymer source module which is in fluid communication with the first pressure module or the second module and wherein the polymer source module provides a polymer to the processing system.

Another embodiment of the present disclosure provides a modular materials processing system comprising a first pressure module comprising from 1 to 12 supercritical fluid processing vessels each having a mechanical mixing device capable of fluidizing an aggregate material or and a supercritical fluid and forming a mixture of the supercritical fluid and the aggregate material wherein a portion of the supercritical fluid is dispersed into gallery spaces of the aggregate material, wherein the supercritical fluid processing vessels are arranged in parallel or in series; a supercritical fluid source module in fluid communication with the first pressure module; an aggregate material source module in fluid communication with the first pressure module; at least one intermediate pressure release valve configured to release the mixture of the supercritical fluid and the aggregate material from the supercritical fluid processing vessels at sonic velocity and produce a depressurized supercritical fluid and a dispersed, exfoliated aggregate material; a second module comprising at least one collection vessel configured to collect the depressurized supercritical fluid and the dispersed, exfoliated aggregate material, the collection vessel being in fluid communication with the supercritical fluid processing vessel through the intermediate pressure release valve; and a recycling module for recycling the depressurized supercritical fluid and in fluid communication with the collection vessel and the supercritical fluid source module or the first pressure module, the recycling module comprising a compressor for repressurizing the supercritical fluid. In other embodiments, the modular materials processing system may comprise a polymer source module which is in fluid communication with the first pressure module or the second module and wherein the polymer source module provides a polymer to the processing system.

### BRIEF DESCRIPTION OF THE DRAWINGS

The various embodiments of the present disclosure will be better understood when read in conjunction with the following Drawings wherein:

FIG. 1A illustrates the structural unit of silicate clay. FIG. 1B illustrates the sheet like structure of a clay aggregate and shows the interlayer spacing or gallery spacing (spacing distance=d) between clay silicate sheets.

FIG. 2 illustrates an embodiment of the modular materials processing system for producing dispersed, exfoliated clay material.

FIG. 3 illustrates an exfoliated clay processing module of the modular materials processing system for mixing a dispersed, exfoliated clay material with a polymer to produce a pelletized batch of a polymer composite material.

FIG. 4 illustrates an embodiment of the modular materials processing system for producing dispersed, exfoliated clay material in a continuous batch process.

FIG. 5 illustrates an embodiment of the modular materials processing system for producing a master batch of polymer composite material.

### DETAILED DESCRIPTION

According to various embodiments, the present disclosure describes a modular system of components that allow an aggregate to be processed using supercritical fluid processing to produce an exfoliated aggregate material or a polymer composite material comprising a polymer and an exfoliated aggregate material. The modular system may be configured according to user need and may be located and installed at a variety of locations, such as off-site or on-site at a manufacturing facility to provide raw material for production of articles of manufacture comprising a polymer composite material. The system allows for controlled and/or automated production of exfoliated aggregate material and/or polymer composite materials comprising the aggregate

As generally used herein, the terms “include” and “have” mean “comprising”. As generally used herein, the term “about” refers to an acceptable degree of error for the quantity measured, given the nature or precision of the measurements. Typical exemplary degrees of error may be within 20%, 10%, or 5% of a given value or range of values. Alternatively, and particularly in biological systems, the term “about” may mean values that are within an order of magnitude, potentially within 5-fold or 2-fold of a given value.

As used herein, the term “aggregate material” includes particulates and powdered materials, and include materials having a structure associated with clays, smectite clays, montmorillonite clays, graphite, carbon black, carbon nanotubes, carbon nanosheets, nanoparticles, calcium carbonate, or other aggregate materials with a structure having gallery spacing between a laminate or sheet like structure.

As used herein, the term “modular” when used in describing a system means a system comprised of individual components or structures that may be ordered in a variety of configurations, including configurations which include or exclude particular components and configurations that include multiple specific component modules that may be arranged in a selected orientation or configuration, such as in parallel or in series, to produce the system. As used herein, the term “module” means a specific component or group of component of the modular system.

As used herein, the term “supercritical fluid” means a substance that when heated and is maintained above its critical temperature, it becomes impossible to liquefy it with pressure. When pressure is applied to this system, a single phase of the substance forms that exhibits unique physicochemical properties. This single phase is termed a supercritical fluid and is characterized by a critical temperature and critical pressure. Supercritical fluids or substantially supercritical fluids may provide favorable means to achieve solvating properties, which have gas and liquid characteristics without actually changing chemical structure. By proper control of pressure and temperature, a significant range of physicochemical properties (density, diffusivity, dielectric constants, viscosity) can be accessed without passing through a phase boundary, e.g., changing from gas to liquid form. Examples of supercritical fluids or substantially supercritical fluids suited for use in the present disclosure include the following compounds: carbon dioxide, acetone, methane, ethane, nitrogen, argon, nitrous oxide, alkyl alcohols, ethylene propylene, propane, pentane, benzene, pyridine, water, ethyl alcohol, methyl alcohol, ammonia, sulfur hexaflouride, hexafluoroethane, fluoroform, chlorotrifluoromethane, or mixtures of any thereof, when maintained under supercritical fluid conditions specific for the particular compound or mixture of compounds. In specific embodiments, the supercritical fluid may be carbon dioxide (CO₂).

As used herein, the term “polymer composite material” means a composite materials comprising a polymeric matrix phase comprising a homopolymer, copolymer, or blend of two or more polymers, and a dispersed phase comprising an exfoliated, aggregate material that may have a size on the micro-, nano- or sub-nanometer scale. In specific embodiments, the dispersed phase may also include other additives, such as, but not limited to, pigments, compatibilizers, oxygen scavengers, stabilizers, UV absorbers, surfactants, and other additives known in the art.

According to certain embodiments, the present disclosure provides for a modular materials processing system comprising a first pressure module comprising at least one supercritical fluid processing vessel, an intermediate pressure release valve, and a second module comprising at least one collection vessel, wherein the at least one collection vessel of the second module is in fluid communication with the at least one supercritical fluid processing vessel of the first pressure module through the intermediate pressure release valve, for example, when the intermediate pressure release valve is in an open position.

According to the various embodiments of the at least one supercritical fluid processing vessel, the vessel may have a mechanical mixing device capable of fluidizing an aggregate material and a supercritical fluid to form a mixture of the supercritical fluid and the aggregate material wherein a portion of the supercritical fluid is dispersed into gallery spaces of the aggregate material. Examples of mechanical mixing devices include, but are limited to, impellers, stirring bars and paddles, agitating devices, and recirculators, jet nozzle, ejectors, eductors, screw impeller, disc, flat blade, propeller, or tumbling mixer. The aggregate material may be introduced into the first pressure module and the at least on supercritical fluid processing vessel where the material is contacted with and mixed with a supercritical fluid, for example in the at least one supercritical fluid processing vessel. Mixing of the aggregate material and the supercritical fluid in the supercritical fluid processing vessel is accomplished by circulating the aggregate material and supercritical fluid in the supercritical fluid processing vessel using the mechanical mixing device. In certain embodiments, the aggregate material is fluidized, such that the aggregate material may become buoyant in a mechanically induced flow field, thereby allowing the aggregate material and the supercritical fluid to be in intimate contact.

In various embodiments the aggregate material may be a platelet aggregates, i.e., a material comprised of stacked platelets with gallery spaces in between the stacked platelets. For example, in certain embodiments the aggregate material may include material selected from a group of silicate, nanoplatelet, nanofiber, and nanotube structures, including silicate clay, montmorillonite clay, smectite clay, zirconium phosphate, zeolites, talc, graphite, carbon black, carbon nanotubes, calcium carbonate, other aggregated materials, and combinations of any thereof. In specific embodiments, the aggregate material may be a silicate clay, a smectite clay or a montmorillonite clay and in particular embodiments, the aggregate material is a montmorillonite clay. Clay minerals are the basic component for the preparation of organoclays, a coventional type of nanofillers. Clay minerals or aggregates may be defined as hydrous-layered silicates which, consist of two types of continuous sheet-like structural units. One is a tetrahedral sheet of silica, which is arranged as a hexagonal network in which the tips of all the tetrahedral units point in one direction. The other structural unit (octahedral sheet) consists of two layers of closely packed oxygen or hydroxyl groups in which aluminum, iron or magnesium atoms are embedded at equidistant from oxygen or hydroxyl as shown in FIG. 1A. Stacking of the layers leads to a regular van der Waals gap between the layers called the interlayer space or silicate gallery (FIG. 1B).

In specific embodiments, the supercritical fluid may be carbon dioxide. When carbon dioxide is used, high-pressurized carbon dioxide is then introduced into the at least one supercritical fluid processing vessel of the first pressurized module and is pressurized in the vessel to above about 7.24 MPa to 70 MPa, and preferably to above about 7.58 MPa. Then, heat is applied to the vessel to heat the vessel to a temperature above about 35° C. to 150° C., and in specific embodiments to above about 70° C. These conditions define a supercritical condition of carbon dioxide wherein a portion of the supercritical carbon dioxide is dispersed into gallery spaces of the aggregate material. However, other ranges may be used for other supercritical fluids without falling beyond the scope or spirit of the present disclosure. Pressurizing and heating the aggregate with the supercritical fluid may be accomplished by any conventional means. It is to be understood that the term “diffuses” mentioned above may be equated to “expands” or “swells” with respect to the supercritical fluid and the aggregated particles. Without intending to be limited by any theory, it is believed that the density properties and the energetic nature of the supercritical fluid allows the supercritical fluid to be dispersed in the gallery spaces of the aggregate materials as they are being mixed in the pressurized and heated supercritical fluid processing vessel. According to various embodiments, the vessel may heated by any conventional heating jacket or electrical heating tape disposed about the vessel. Moreover, diffusing the supercritical fluid between the aggregated particles includes maintaining diffusion for between about 10 minutes to 24 hours at supercritical conditions and preferably from 3 to 10 hours, to produce a mixture of supercritical fluid and the aggregate material comprising contacted particles.

When there has been sufficient mixing of the aggregate material and the supercritical fluid, such that a portion of the supercritical fluid is dispersed in gallery spaces of the aggregate material to form the mixture of the supercritical fluid and the aggregate material, the mixture is expelled from the supercritical fluid processing vessel, through the intermediate pressure release valve, into the at least one collection vessel. The at least one collection vessel is maintained at a pressure less than the pressure of the mixture in the supercritical fluid processing vessel, such as, for example about atmospheric pressure or even reduced pressure. The intermediate pressure release valve is configured to release the mixture of the supercritical fluid and aggregate material, for example at up to sonic velocity. As the mixture is expelled from the supercritical fluid processing vessel through the intermediate pressure release valve and into the second module and the at least one collection vessel, the mixture of supercritical fluid and aggregate material is catastrophically depressurized, wherein the supercritical fluid, including the supercritical fluid in the gallery spaces, expands where the molecules of the supercritical fluid move away from each other at a sonic velocity and the aggregate particles also move away from each other at a similar apparent velocity. Due to a portion of the supercritical fluid molecules being entrained in the aggregate gallery spaces of the aggregate material, the aggregate material is torn apart during the catastrophic depressurization by forces when the supercritical fluid molecules expand against the gallery walls and layers of the aggregate material. After and as a result of the catastrophic depressurization, the contacted aggregate material particles are exfoliated such that the particles are substantially delaminated and disordered, preventing reaggregation of the structures, and producing a dispersed, exfoliated aggregate material.

According to various embodiments, the at least one collection vessel of the second module collects the depressurized supercritical fluid and the dispersed, exfoliated aggregate material. For example, when the intermediate pressure release valve is opened, the collection vessel is in fluid communication with the at least one supercritical fluid processing vessel and, due to the difference in pressure between the supercritical fluid processing vessel (while the intermediate pressure release valve is in the closed position) and the at least one collection vessel, when the intermediate pressure release valve is placed in the open position, the mixture of supercritical fluid and aggregate is catastrophically depressurized as it moves to the at least one collection vessel, resulting in the dispersed, exfoliated aggregate material and the depressurized supercritical fluid. For example, as the mixture of supercritical fluid and aggregate enters the collection vessel in a jet, such as via a nozzle in the intermediate pressure release valve, the supercritical fluid in the jet expands under the reduced pressure such that the aggregate material becomes a substantially dispersed, finely divided aggregate composed of micron to nanometer sized particles and tactoids. As used herein, the term “tactoids” means particles comprising dispersed clay platelets and stacks of platelets.

In specific embodiments, the modular materials processing system may further comprise a supercritical fluid source module in fluid communication with a first pressure module, for example with the at least one supercritical fluid processing vessel. According to these embodiments, the supercritical fluid may be transferred to the supercritical fluid processing vessel for combination with the aggregate material. The supercritical fluid material may be in a pressurized state when transferred to the supercritical fluid processing vessel or, alternatively, the supercritical fluid material may be at about atmospheric pressure and then subsequently pressurized in the supercritical fluid processing vessel. In certain embodiments, the supercritical fluid may be mixed with the aggregate material, for example in the supercritical fluid source module or when the supercritical fluid is transferred from the supercritical fluid source module to the supercritical fluid processing vessel, such as, for example in an intermediate slurry vessel, where a slurry of the supercritical fluid and the aggregate material is formed. In other embodiments, the modular materials processing system may further comprise an aggregate material source module in fluid communication with the first pressure module, for example, in fluid communication with at least one supercritical fluid processing vessel. The aggregate material source module may transfer the aggregate material from the source module to the first pressure module, either directly or via the supercritical fluid source module, for example via an auger, gravity feeder, or other material transfer device.

In various embodiments, the first pressure module may further comprise a sample module for sampling the mixture of supercritical fluid and aggregate material, and optionally polymer, while the material is in the supercritical fluid processing vessel. According to these embodiments, the sample module may comprise a sample vessel in fluid communication with the supercritical fluid processing vessel via a communicating port and a sample collection vessel in fluid communication with the sample vessel via a sample pressure release valve. The sample vessel may be located inside the supercritical fluid processing vessel and may be configured to sample the contents of the supercritical fluid processing vessel via the communicating port. For example, during mixing, the mixture of the supercritical fluid and the aggregate material, and optionally polymer, may move into the sample vessel via the communicating port during processing such that the contents of the sample vessel are substantially homogeneous with and essentially the same as the contents of the supercritical fluid processing vessel under essentially the same conditions, such as supercritical conditions, temperature and pressure, to provide a real time sample of the contents of the supercritical fluid processing vessel. The sample vessel may be further so that the communicating port will rapidly close when the sample pressure release valve is rapidly opened. When the sample pressure release valve is rapidly opened, the communicating port rapidly closes, isolating the contents of the sample vessel from the supercritical fluid processing vessel. Further, upon opening of the sample pressure release valve a sample of the mixture of the supercritical fluid and the aggregate material, and optionally polymer, within the sample vessel is sonically discharged and catastrophically depressurized from the sample vessel into the sample collection vessel. Upon discharge and catastrophic depressurization, the aggregate material in the sample mixture in is dispersed and exfoliated, as described herein, to produce a sample, dispersed, exfoliated aggregate material, optionally as a nanocomposite. Testing may be performed on the sample material to determine how the process is proceeding. In specific embodiments, the sample collection vessel may be in fluid communication with the recycling module so that the depressurized supercritical fluid may be cycled through the recycling module as described herein.

In certain embodiments, the modular materials processing system may further comprise a recycling module for recycling the depressurized supercritical fluid, for example, for re-use in the process. The recycling module may be in fluid communication with the at least one collection vessel and the supercritical fluid source module or the first pressure module. In specific embodiments, the recycling module may comprise a compressor suited for repressurizing the supercritical fluid material prior to return to the supercritical fluid source module or first pressure module. In other embodiments, the recycling module may further comprise one or more filtration devices, wherein the filtration devices may filter remove residual processed, exfoliated aggregate material from the recycle stream and return the filtered aggregate material to the collection vessel, or alternatively dispose of the filtered aggregate material. According to other embodiments, the recycling module may comprise one or more pressure or vacuum pumps for pressurizing and/or moving the depressurized supercritical fluid to the supercritical source module. In other embodiments, the recycling module may further comprise at least one recycled supercritical storage vessel.

In particular embodiments, the first pressure module may comprise two or more supercritical fluid processing vessels. The two or more supercritical fluid processing vessels may be arranged in parallel or in series, and are in fluid communication with the at least one collection vessel through the intermediate pressure release valve or additional intermediate pressure release valves. The two or more supercritical fluid processing vessel may be configured such that the release of mixtures of supercritical fluid and aggregate material from each of the two or more supercritical fluid processing vessels may be in a timed, overlapping sequence to produce a semi continuous batch process. The various embodiments of the materials processing systems may be configured to have one, two or more supercritical fluid processing vessels to produce the dispersed, exfoliated aggregate material in a manner and quantity necessary to meet the needs of the user. In certain embodiments, the two or more supercritical fluid processing vessels may be arranged in parallel and configured to sequentially release the individual quantities of mixtures of supercritical fluid and aggregate material.

According to other embodiments, the modular materials processing system described herein may further comprise one or more additional pressure modules. Each of the one or more additional pressure modules may comprise one or more supercritical fluid processing vessels which may be arranged in parallel or in series, and are in fluid communication with the at least one collection vessel through the intermediate pressure release valve or one or more additional intermediate pressure release valves. According to these embodiments, the one or more additional pressure modules may be configured to mix additions mixtures of supercritical fluid and aggregate material wherein a portion of the supercritical fluid is dispersed into gallery spaces of the aggregate material. Further, the one or more additional pressure modules may release the additional mixtures of supercritical fluid and aggregate material into the at least one collection vessel through the intermediate pressure release valve or one or more additional pressure release valves in a timed, overlapping sequence with the first pressure module. According to these embodiments, the modular materials processing system may be designed to produce industrially useful amounts of material.

In other embodiments, the modular materials processing system of the present disclosure may be configured to produce a polymer composite material comprising a polymer matrix and a dispersed, exfoliated aggregate material. According to certain embodiments, the second module may further comprise a composite mixing module in fluid communication with the at least one collection vessel and a polymer source module in fluid communication with the composite mixing module. According to these embodiments, the composite mixing module may be configured to mix the polymer from the polymer source module with the dispersed, exfoliated aggregate material from the at least one collection vessel to produce the polymer composite material. The polymer from the source module and the aggregate from the at least one collection vessel may be fed to the composite mixing module by any means, such as by gravity feed, auger, or the like. The composite mixing module may mix the polymer and the exfoliated aggregate material to produce a composite material having a uniformly dispersed exfoliated aggregate material dispersed in the polymer matrix. Suitable composite mixing modules may comprise an extruder, impeller, or other polymeric mixing device. The polymeric composite material may exit the composite mixing module and be collected or transferred to a processing unit, such as a pelletizer to produce polymer composite pellets or a packaging operation to produce a polymer composite material for immediate or later use, either on site or off site.

The polymer source module may provide any polymer suited for forming a dispersed polymeric composite material with the exfoliated aggregate material. For example, the polymer may be a polyolefin, a polyester, a polyamide, a polycarbonate, and mixtures and copolymers of any thereof. In specific embodiments, the polymer may be selected from the group consisting of polyvinyl chloride (“PVC”), polyethylene terephthalate, polyacrylonitrite, high density polyethylene (“HDPE”), polyethylene terephthalate (“PETE”), polyethylene triphallate (“PET”), polycarbonate, polyolefins, polypropylene, polystyrene, low density polyethylene (“LDPE”), linear low density polyethylene (“LLPE”), polybutylene terephthalate, ethylene-vinyl acetate, acrylic-styrene-acrylonitrile, melamine and urea formaldehyde, polyurethane, acrylonitrile-butadiene-styrene, phenolic, polybutylene, polyester, chlorinated polyvinyl chloride, polyphenylene oxide, epoxy resins, polyacrylics, polymethyl methacrylate, acetals, acrylics, amino resins cellulosics, polyamides, phenol formaldehyde, nylon, polytetrafluoroethylene, and blends and copolymers of any thereof. In particular embodiments, the polymer may be polyethylene, including HDPE, LDPE, and LLPE, or polypropylene.

In specific embodiments, the processing unit may be a pelletizing module. According to certain embodiments, the pelletizing module may be configured to treat the polymer composite material and form a pelletized polymer composite material comprising a predetermined material load, i.e., a predetermined loading of aggregate material in a polymeric matrix. For example, specific end users of the polymer composite material may require a specific material load to provide desired properties and characteristics of the polymer composite material. In these embodiments, the composite mixing module may be configured to mix the appropriate quantities of polymer and exfoliated aggregate to produce the desired material load for the composite, such that the composite pellets have the desired predetermined material load according to desired end use. In various embodiments, the polymer composite material may comprise a predetermined material load of from 1% to 50% by weight of the exfoliated aggregate material dispersed in the polymer matrix. According to other embodiments, the polymer composite may have a material load of from 1% to 40% by weight, or even 10% to 20% by weight. According to other embodiments, the polymer composite may have a material load of from 1% to 5% by weight of the dispersed, exfoliated aggregate material.

According to other embodiments of the modular materials processing system, the system may further comprise a polymer source module in fluid communication with the first pressure module, such as the one or more supercritical fluid processing vessels. According to these embodiments, the polymer source module may provide a polymer for mixing with the supercritical fluid and the aggregate material in the at least one supercritical fluid processing vessel. During the mixing, the polymer may be solubilized in the supercritical fluid and deposit on the aggregate material surface or deposit in the gallery spaces of the aggregate material during mixing to form a mixture of supercritical fluid, polymer, and aggregate material, where a portion of the supercritical fluid and a portion of the polymer are dispersed into the gallery spaces of the aggregate materials. When the mixture of supercritical fluid, polymer, and aggregate material are mixed and the catastrophically decompressed to form exfoliated aggregate material, the decompressive forces may form a polymer composite material wherein the exfoliated aggregate material may be dispersed in the polymer matrix of the polymeric material and the polymer composite material having the dispersed exfoliated aggregate material may be collected in the at least one collection vessel of the second module. According to various embodiments, the polymer may be a polyolefin selected from the group consisting of polyvinyl chloride (PVC), polyethylene terephthalate, polyacrylonitrite, high density polyethylene (HDPE), polyethylene terephthalate (PETE), polyethylene triphallate (PET), polycarbonate, polyolefins, polypropylene, polystyrene, low density polyethylene (LDPE), linear low density polyethylene (“LLPE”), polybutylene terephthalate, ethylene-vinyl acetate, acrylic-styrene-acrylonitrile, melamine and urea formaldehyde, polyurethane, acrylonitrile-butadiene-styrene, phenolic, polybutylene, polyester, chlorinated polyvinyl chloride, polyphenylene oxide, epoxy resins, polyacrylics, polymethyl methacrylate, acetals, acrylics, amino resins cellulosics, polyamides, phenol formaldehyde, nylon, polytetrafluoroethylene, and blends and copolymers of any thereof. In particular embodiments, the polymer may be polyethylene or polypropylene.

In specific embodiments, the at least one collection vessel may comprise an extruder that is capable of extruding the polymer composite material comprising the polymer and the dispersed, exfoliated aggregate material. According to certain embodiments, the polymer composite material may be extruded or otherwise removed from the at least one collection vessel in the form of a “master batch”. As used herein, the term “master batch” means a batch of polymer composite material having a set material loading of the dispersed exfoliated aggregate material that may be provided to the user as a pelletized composite material produce, a block composite material produce or other bulk form of the polymer composite material. The user may then process the master batch as necessary, for example, diluting or mixing the polymer composite material with other materials, such as other polymers and/or additives, to produce the desired material composition. Alternatively, the user may use the master batch “as is”, i.e., with the produced materials load. According to certain embodiments, the polymer composite material may be in a master batch comprising from 25% to 50% by weight of the dispersed, exfoliated aggregate material and from 50% to 75% by weight of the polymer. According to other embodiments, the master batch may comprise from 35% to 50%, or even from 40% to 50% by weight of the exfoliated aggregate material and from 50% to 65%, or even from 50% to 60%, respectively, by weight of the polymer.

According to other embodiments, the present disclosure provides a modular materials processing system comprising a first pressure module comprising 1 to 12 supercritical fluid processing vessels each having a mechanical mixing device capable of fluidizing an aggregate material and a supercritical fluid and forming a mixture of the supercritical fluid and the aggregate material, as described herein, 1 wherein a portion of the supercritical fluid is dispersed into gallery spaces of the aggregate material, wherein the supercritical fluid processing vessels are arranged in parallel or in series; a supercritical fluid source module in fluid communication with the first pressure module; an aggregate material source module in fluid communication with the first pressure module; at least one intermediate pressure release valve configured to release the mixture of the supercritical fluid and the aggregate material from the supercritical fluid processing vessels at sonic velocity and produce a depressurized supercritical fluid and a dispersed, exfoliated aggregate material; a second module comprising at least one collection vessel configured to collect the depressurized supercritical fluid and the dispersed, exfoliated aggregate material, the collection vessel being in fluid communication with the supercritical fluid processing vessel through the intermediate pressure release valve; and a recycling module for recycling the depressurized supercritical fluid and in fluid communication with the collection vessel and the supercritical fluid source module or the first pressure module, the recycling module comprising a compressor for repressurizing the supercritical fluid. According to various embodiments, the materials processing system may further comprise a polymer source module in fluid communication with the first pressure module or the second module, wherein the polymer source module provides a polymer to the processing system.

According to certain embodiments, the second module may comprise a composite mixing module in fluid communication with the at least one collection vessel and wherein the polymer source module is in fluid communication with the composite mixing module of the second module. In particular embodiment, the composite mixing module is configured to mix a polymer and the dispersed, exfoliated aggregate material to produce a polymer composite material. In specific embodiments, the polymer composite material may comprise a predetermined material load of from 1% to 50% by weight of the dispersed, exfoliated aggregate material. According to other embodiments, the polymer composite may have a material load of from 15% to 50% by weight, or even 25% to 50% by weight. In particular embodiments, the polymer composite material may be treated to form a pelletized polymer composite material. According to another embodiment, the polymer composite material may be in the form of a master batch.

According to other embodiments, the polymer source module may be in fluid communication with the first module. In specific embodiments, the polymer source module may provide a polymer for mixing with the supercritical fluid and the aggregate material in the 1 to 12 supercritical fluid processing vessels. According to certain embodiments, the modular material processing system may comprise an extruder from the at least one collection vessel where the extruder extrudes the polymer composite material comprising the polymer and the dispersed, exfoliated aggregate material, for example as a master batch. In specific embodiments, where the polymer composite material is in the form of a master batch, the composite material may comprise from 25% to 50% by weight of the dispersed, exfoliated aggregate material and from 50% to 75% by weight of the polymer. According to other embodiments, the master batch may comprise from 35% to 50%, or even from 40% to 50% by weight of the exfoliated aggregate material and from 50% to 65%, or even from 50% to 60%, respectively, by weight of the polymer. The master batch polymer composite material may be provided to a user in bulk, for example as a block material, or as a pelletized material.

According to various embodiments, the supercritical fluid may be any supercritical fluid described herein, such as, in certain embodiments, carbon dioxide. The aggregate material may be a platelet aggregate such as described herein. In specific embodiments, the aggregate may be a silicate clay, montmorillonite clay, smectite clay, graphite, carbon black, carbon nanotubes, calcium carbonate, or combinations of any thereof. The polymer utilized in the various embodiments for producing the polymer composite material may be a matrix polymer such as described herein, including for example a polyolefin, such as polyethylene, polypropylene, polyvinyl chloride, polyethylene terephthalate, polyacrylonitrile, polyethylene triphallate, polystyrene, polybutylene, polybutylene terephthalate, polyacrylics, polymethyl (meth)acrylate, polytetrafluoroethylene, or blends or copolymers of any thereof. In specific embodiments, the polymer may be polyethylene, such as, for example high density polyethylene, low density polyethylene, or linear low density polyethylene. In other embodiments, the polymer may be polypropylene.

In certain embodiments, the modular materials processing system described herein may be configured such that the first pressure module may comprise from 2 to 12 supercritical fluid processing vessels that are configured to release mixtures of supercritical fluid and aggregate material, and optionally polymer, mixed in each processing vessel into the at least one collection vessel through the at least one intermediate pressure release valve, wherein the release of the mixture of supercritical fluid, aggregate material, and optionally polymer, from each of the 1 to 12 supercritical fluid processing vessels is configured as a timed, overlapping or non-overlapping sequence. In certain embodiments, the timed release may allow for production of the exfoliated aggregate or polymer composite material in a continuous batch cycle.

Specific embodiments of the modular materials processing system will be described with reference to the Figures. FIG. 2 displays one embodiment of the modular materials processing system capable of producing dispersed exfoliated clay on an industrial scale using the various modular components described herein. Referring to FIG. 2, the modular materials processing system 200 includes a first pressurized module 220 comprising a 10 L supercritical fluid processing vessel 206 which are in fluid communication via intermediate pressure release valve 204 with the second module 230 comprising a 1800 L collection vessel 209 including a clay collection area 210. Processing vessels 206 include mechanical mixing device 207 and heating jacket 208 to control the temperature and thereby the pressure of vessel 206. Aggregate materials source module 205 and supercritical fluid source module 201 (via chiller 202, pressure pump 203 and three-way valve 219) are in fluid communication with supercritical fluid processing vessel 206. Exfoliated clay exits collection vessel 209 through valve 212A to clay collection area 210 and proceeds to packaging operation 211 via a quality control process or can be sent to a polymer composite processing module 240. Recycling module 250 is in fluid communication with collection vessel 209 and depressurized supercritical fluid exits vessel 209 via valve 221, is filtered at filters 213 using vacuum pump 214 to remove residual processed aggregate and then is repressurized by compressor 215 and collected in pressurized supercritical fluid vessel 216 and returned to the first pressurized module via three-way valve 219 of via chiller 202.

FIG. 3 displays a polymer composite material processing module 300 (see also module 240 or 450 of FIGS. 2 and 4, respectively) of the modular materials processing system according to the present disclosure. Referring to FIG. 3, polymer composite material processing module 300 includes a source of exfoliated clay 306 to feed the exfoliated clay into batch mixer extruder 332 including heat source 333 via a gravity feed. Polymer source module 307 feeds polymer material into mixer extruder 332 via a gravity feed. The polymer and the exfoliated clay is mixed and extruded to produce a polymer composite material which is transferred to cooling station 335 and then undergoes a quality control inspection 337. Polymer composite material that passes the quality control is then transferred to pelletizer 336 and the pellets packaged in packaging operation 317 and shipped to the user. Polymer composite material that fails quality control is either reworked or disposed of.

FIG. 4 illustrates a modular materials processing system as described herein for a semi-continuous batch production process for producing an exfoliated aggregate material comprising a clay. Referring to FIG. 4, the modular materials processing system 400 includes a first pressurized module 410 comprising a 10 L supercritical fluid processing vessel 409 and a second and third 10 L supercritical fluid processing vessel 411 arranged in parallel which are in fluid communication via intermediate pressure release valve 403 with the second module 430 comprising a 1800 L collection vessel 415 including a clay collection area 431. Processing vessels 409 and 411 include mechanical mixing device 412 along with recirculator 413 for recirculating the mixture and heating jacket 408 to control the temperature and thereby the pressure of vessels 409 and 411. Aggregate materials source module 406 and supercritical fluid source module 401 (via chiller 404, pressure pump 405 and three-way valve 402) are in fluid communication with slurry vessel 441 of first pressure module 410. Exfoliated aggregate material exits collection vessel 415 through valve 432, passes a quality control review 433 and proceeds to packaging operation 416 or can be sent to a polymer composite processing module 450. Recycling module 440 is in fluid communication with collection vessel 415 and depressurized supercritical fluid exits vessel 415 via valve 442, is filtered at filters 418 using vacuum pump 419 to remove residual processed aggregate and then is repressurized by compressor 420 and collected in pressurized supercritical fluid vessel 421 and returned to the first pressurized module via three-way valve 402.

FIG. 5 illustrates a modular materials processing system as described herein for a semi-continuous batch production process for producing a polymer composite material. Referring to FIG. 5, the modular materials processing system 500 includes a first pressurized module 510 comprising three 10 L supercritical fluid processing vessels 508 arranged in parallel which are in fluid communication via intermediate pressure release valve 503 with polymer composite material processing module 530. Processing vessels 508 include mechanical mixing device 514 and heating jacket 509 to control the temperature and thereby the pressure of vessels 508. Aggregate materials source module 506, supercritical fluid source module 501 (via chiller 504 and pressure pump 505) and polymer source module 507 are in fluid communication first pressure module 510 and processing vessels 508 via four-way valve 502. Polymer composite material exits processing vessels 508 via valve 503 and proceed to polymer composite processing module 530. As the polymer composite material exits valve 503 into the polymer composite material processing module, the composite material passes through extruder 534 to produce a homogeneous dispersed polymer composite, is transferred to cooling station 535 and then undergoes a quality control inspection 537. Polymer composite material that passes the quality control is then transferred to pelletizer 536 and the pellets packaged in packaging operation 517 and shipped to the user. Polymer composite material that fails quality control is either reworked or disposed of Recycling module 540 is in fluid communication with valve 503 and depressurized supercritical fluid exits vessels 508 via valve 503, is filtered at filter 518 to remove residual processed aggregate and then is repressurized by compressor 520 and collected in pressurized supercritical fluid vessel 521 and returned to the first pressurized module 510 via chiller 504.

The various embodiments of the modular materials processing system described herein may be better understood when read in conjunction with the following non-limiting examples. One of skill in the art would understand that the present disclosure is not limited to the embodiments and configurations set forth and described herein. The present disclosure also includes other configuration of the various components described herein that would be apparent to one of skill in the art reading the present disclosure.

### EXAMPLES

### General Methods and Precautions

The following precautions were taken when using the modular materials processing systems according to various embodiments described herein. High pressure gasses have the potential for causing serious injury. In some cases, the force of the gas system can topple an unsecured cylinder. Objects propelled by the release of gas may strike personnel at high speed. Pressure must be completely vented off of the system prior to opening the reactor vessel. Direct contact with a concentrated stream of gas discharged under high pressure can strip away human flesh. Exposure of the skin to gaseous or solid carbon dioxide can result in frost bite, a cryogenic injury resembling a burn. The experimental procedures for producing exfoliated aggregate applicable to operating the 250 ml high pressure reactor and all connected co2 piping, controllers and valving. A carbon dioxide cylinder is lined up to modular materials processing system. A new CO₂ cylinder should indicate approximately 850 psig. Minimum useful pressure is approximately 600 psig.

### Example 1

### Reactor System to Produce Dispersed, Exfoliated Nanomaterial

Prior to preparing the dispersed, exfoliated nanomaterial, the following prerequisite operations were performed. A system valve lineup was performed. The pressure controller of the first pressure module is set for 3,400 pounds per square inch (psi). The temperature controller for the first pressure module was set for 80° C. The mechanical mixing device in the supercritical fluid processing vessel was set for medium speed. Stirrer control switch is in <O> position. Prior to charging, the supercritical fluid processing vessel head was removed and the vessel interior was cleaned.

The supercritical fluid processing vessel was loaded with 15 g of clay and the vessel was closed and the reactor vessel head screws were tightened to 20 foot-pounds of torque using an alternating torquing pattern. Next the head screws were tightened to 40 foot-pounds of torque using an alternating torquing pattern.

The pressure setting of the supercritical fluid processing vessel was checked to ensure appropriate pressure setting. The pump inlet valve was opened (syringe other positive displacement pump) and the controller refill push-button was depressed. The syringe pump was filled with carbon dioxide (267 mL) over 2 min, 26 sec. The pump controller will display approximately the same pressure as the CO₂ tank (850 psi for new bottle) and the fill rate is approximately 267 mL/min when the pump is full. The syringe pump inlet valve was closed and the pump stopped. The controller run push-button was depressed and the syringe pump pressurized the pump outlet piping. The pump controller displays an approximate increasing pressure as the pump operates (pressure set to 3400 psi) and the discharge rate in mL/min and approximately 0 mL to 50 mL when the pump has completely discharged. The reactor vessel gas backup valve was positioned to direct the flow to the reactor vessel during reactor vessel operation. The syringe pump outlet valve and the reactor vessel gas inlet valve were opened and the reactor processing vessel pressurized, as shown on the vessel pressure gauge and the transducer display on controller. The syringe pump outlet valve and the reactor processing vessel gas inlet valve were closed once pressurization ceased. The process was repeated until the processing vessel pressure on the controller transducer display reads about 3000 to 3300 psi, upon which time the stirrer speed was increased to maximum. The mixture in the reactor processing vessel was stirred under supercritical conditions of about 3000 psi for four hours. The CO₂ recycling system was placed in the open position and the intermediate pressure release valve was swiftly opened and the system was rapidly and catastrophically depressurized, wherein the system pressure decays to 0 psi in less than 10 seconds and the clay is expelled into the collection vessel as a dispersed, exfoliated clay. The CO₂ is sent to the recycling module for recycling. The dispersed, exfoliated clay was collected and removed from the collection vessel.

### Example 2

### Master Batch Preparation

A master batch polymer composite material was prepared using the dispersed, exfoliated clay from Example 1. Sufficient dispersed, exfoliated clay is prepared and weighed to provide a 1% to 20% by weight mixture of nanocomposite polymer material. Sufficient polymer is weighed to provide a 1% to 20% by weight mixture of nanocomposite polymer material.

Parameters for the extruder, cooling station, pelletizer, polymer gravimetric feeder, nanofiller gravimetric feeder are set. The extruder is started and the clay and the polymer are fed into the extruder. The heated nanocomposite polymer material is fed through the extruder and the output sent to the cooling station. After cooling the cooled polymer composite is sent to the pelletizer and pelletized and then collected from the output of the pelletizer to provide a pelletized master batch of polymer composite material having a set loading of the dispersed, exfoliated aggregate material.

### Example 3

### Preparation of Exfoliated Nanoclay and Polymer Nanocomposite Material

Prior to preparing the polymer nanocomposite material having dispersed, exfoliated nanoclay, the following prerequisite operations were performed. A system valve lineup was performed. The pressure controller of the first pressure module is set for 3,400 pounds per square inch (psi). The temperature controller for the first pressure module was set for 80° C. to 300° C. The mechanical mixing device in the supercritical fluid processing vessel was set for medium speed. Stirrer control switch is in <O> position. Prior to charging, the supercritical fluid processing vessel head was removed and the vessel interior was cleaned.

The supercritical fluid processing vessel is loaded with an appropriate amount of clay to obtain a 1% to 20% by weight final nanocomposite polymer mixture, depending on the polymer used. Sufficient polymer is weighed to provide a 1% to 20% by weight mixture of nanocomposite polymer material. The clay and the polymer material are placed in the reactor and dry mixed. The total weight of the clay and the polymer material is in the range of 50 g to 150 g. The vessel is closed and the reactor vessel head screws are tightened to 20 foot-pounds of torque using an alternating torquing pattern. Next the head screws are tightened to 40 foot-pounds of torque using an alternating torquing pattern. The supercritical fluid processing vessel is heated and when the melt temperature of the polymer is reached, stirring is started by placing the stirring motor switch in the on position. The contents of the processing vessel are stirred for approximately 10 minutes prior to pressurizing with the supercritical fluid.

The pressure setting of the supercritical fluid processing vessel is checked to ensure appropriate pressure setting. The pump inlet valve is opened (syringe other positive displacement pump) and the controller refill push-button is depressed. The syringe pump is filled with carbon dioxide (267 mL) over 2 min, 26 sec. The pump controller will display approximately the same pressure as the CO₂ tank (850 psi for new bottle) and the fill rate is approximately 267 mL/min when the pump is full. The syringe pump inlet valve is closed and the pump stopped. The controller run push-button is depressed and the syringe pump pressurized the pump outlet piping. The pump controller displays an approximate increasing pressure as the pump operates (pressure set to 3400 psi) and the discharge rate in mL/min and approximately 0 mL to 50 mL when the pump has completely discharged. The reactor processing vessel gas backup valve is positioned to direct the flow to the reactor processing vessel during reactor processing vessel operation. The syringe pump outlet valve and the reactor processing vessel gas inlet valve are opened and the processing vessel pressurized, as shown on the vessel pressure gauge and the transducer display on controller. The syringe pump outlet valve and the reactor vessel gas inlet valve are closed once pressurization is achieved. The process is repeated until the reactor pressure on the controller transducer display reads about 3000 to 3300 psi, upon which time the stirrer speed is increased to maximum.

The mixture in the processing vessel is stirred under supercritical conditions of about 3000 psi for four to six hours. The CO₂ recycling system was placed in the open position and the intermediate pressure release valve was swiftly opened and the system was rapidly and catastrophically depressurized, wherein the processing vessel decays to 0 psi in less than 10 seconds. CO₂ is expelled into the collection vessel and then sent to the recycling module for recycling. The nanocomposite material is expelled into a collection vessel as a composite having a dispersed, exfoliated clay, using gravity, pumping, or some other means.

Upon discharge, the system pressure is 0 psi and the system temperature will have decreased during vessel depressurization. If the temperature of the system is less than the appropriate temperature, allow the temperature to increase. The parameters of the extruder, the cooling system and the pelletizer are set. To harvest the nanocomposite polymer material, the nanocomposite polymer material is fed through the extruder and the output sent to the cooling station. After cooling the cooled polymer composite is sent to the pelletizer and palletized and then collected from the output of the pelletizer to provide a pelletized master batch of polymer nanocomposite material having a set loading of the dispersed, exfoliated clay material.

Unless otherwise indicated, all numbers expressing quantities of ingredients, properties such as molecular weight, reaction conditions, and so forth used in the specification and claims are to be understood as being modified in all instances by the term “about”. Accordingly, unless indicated to the contrary, the numerical parameters set forth in the specifications and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

All numerical ranges stated herein include all sub-ranges subsumed therein. For example, a range of “1 to 10” is intended to include all sub-ranges between and including the recited minimum value of 1 and the recited maximum value of 10. Any maximum numerical limitation recited herein is intended to include all lower numerical limitations. Any minimum numerical limitation recited herein is intended to include all higher numerical limitations.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, for any reference made to patents and printed publications throughout this specification, each of the cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

We claim:

1. A modular materials processing system comprising:
a first pressure module comprising at least one supercritical fluid processing vessel having a mechanical mixing device capable of fluidizing an aggregate material and a supercritical fluid and forming a mixture of the supercritical fluid and the aggregate material wherein a portion of the supercritical fluid is dispersed into gallery spaces of the aggregate material;
an intermediate pressure release valve configured to release the mixture of the supercritical fluid and the aggregate material from the supercritical fluid processing vessel at sonic velocity and produce a depressurized supercritical fluid and a dispersed, exfoliated aggregate material; and
a second module comprising at least one collection vessel configured to collect the depressurized supercritical fluid and the dispersed, exfoliated aggregate material, the collection vessel being in fluid communication with the supercritical fluid processing vessel through the intermediate pressure release valve.

2. The modular materials processing system according to claim 1, wherein the first pressure module further comprises a sample module comprising a sample vessel in fluid communication with the supercritical fluid processing vessel via a communicating port and a sample collection vessel in fluid communication with the sample vessel via a sample pressure release valve,
wherein the sample vessel is located inside the supercritical fluid processing vessel and configured to sample contents of the supercritical fluid processing vessel via the communicating port, and configured so that the communicating port is rapidly closed when the sample pressure release valve is rapidly opened,
wherein a sample of the mixture of the supercritical fluid and the aggregate material is sonically discharged and catastrophically depressurized from the sample vessel into the sample collection vessel when the sample pressure release valve is opened.

3. The modular materials processing system according to claim 1, further comprising a supercritical fluid source module in fluid communication with the first pressure module; and
an aggregate material source module in fluid communication with the first pressure module.

4. The modular materials processing system according to claim 3, further comprising a recycling module for recycling the depressurized supercritical fluid and in fluid communication with the collection vessel and the supercritical fluid source module or the first pressure module, the recycling module comprising a compressor for repressurizing the supercritical fluid.

5. The modular materials processing system according to claim 1, wherein the first pressure module comprises two or more supercritical fluid processing vessels arranged in parallel or in series and in fluid communication with the at least one collection vessel through the intermediate pressure release valve, wherein the release from each of the two or more supercritical fluid processing vessels are configured to release the mixtures of supercritical fluid and aggregate material in a timed, overlapping sequence.

6. The modular materials processing system according to claim 1, further comprising one or more additional pressure modules each comprising one or more supercritical fluid processing vessels arranged in parallel or in series and in fluid communication with the at least one collection vessel through the intermediate pressure valve or one or more additional intermediate pressure release valves,
wherein the one or more additional pressure modules are configured to mix additional mixtures of supercritical fluid and aggregate material wherein a portion of the supercritical fluid is dispersed into gallery spaces of the aggregate material, and release the additional mixtures into the at least one collection vessel through the intermediate pressure valve or one or more additional intermediate pressure release valves in a timed, overlapping sequence with the first pressure module.

7. The modular materials processing system according to claim 1, wherein the supercritical fluid is carbon dioxide, methane, ethane, nitrogen, argon, nitrous oxide, alkyl alcohols, ethylene propylene, propane, pentane, benzene, pyridine, water, ethyl alcohol, methyl alcohol, ammonia, sulfur hexaflouride, hexafluoroethane, fluoroform, chlorotrifluoromethane, or mixtures of any thereof.

8. The modular materials processing system according to claim 1, wherein the aggregate material is a material selected from the group consisting of a silicate, nanoplatelet, nanofiber, and nanotube structures,

9. The modular materials processing system according to claim 8, wherein the aggregate material is a material selected from silicate clay, montmorillonite clay, smectite clay, zirconium phosphate, zeolites, talc, graphite, carbon black, carbon nanotubes, calcium carbonate, other aggregated materials, and combinations of any thereof.

10. The modular materials processing system according to claim 1, wherein the second module further comprises a composite mixing module in fluid communication with the at least one collection vessel and a polymer source module in fluid communication with the composite mixing module,
wherein the composite mixing module is configured to mix a polymer from the polymer source module and the dispersed, exfoliated aggregate material to produce a polymer composite material.

11. The modular materials processing system according to claim 10, wherein the first pressure module further comprises a sample module comprising a sample vessel in fluid communication with the supercritical fluid processing vessel via a communicating port and a sample collection vessel in fluid communication with the sample vessel via a sample pressure release valve,
wherein the sample vessel is located inside the supercritical fluid processing vessel and configured to sample contents of the supercritical fluid processing vessel via the communicating port, and configured so that the communicating port is rapidly closed when the sample pressure release valve is rapidly opened,
wherein a sample of the mixture of the supercritical fluid and the aggregate material is sonically discharged and catastrophically depressurized from the sample vessel into the sample collection vessel when the sample pressure release valve is opened.

12. The modular materials processing system according to claim 10, wherein the polymer is a polyolefin selected from the group consisting of polyvinyl chloride (PVC), polyethylene terephthalate, polyacrylonitrite, high density polyethylene (HDPE), polyethylene terephthalate (PETE), polyethylene triphallate (PET), polycarbonate, polyolefins, polypropylene, polystyrene, low density polyethylene (LDPE), linear low density polyethylene (“LLPE”), polybutylene terephthalate, ethylene-vinyl acetate, acrylic-styrene-acrylonitrile, melamine and urea formaldehyde, polyurethane, acrylonitrile-butadiene-styrene, phenolic, polybutylene, polyester, chlorinated polyvinyl chloride, polyphenylene oxide, epoxy resins, polyacrylics, polymethyl methacrylate, acetals, acrylics, amino resins cellulosics, polyamides, phenol formaldehyde, nylon, polytetrafluoroethylene, and blends and copolymers of any thereof.

13. The modular materials processing system according to claim 12, wherein the polymer is polyethylene or polypropylene.

14. The modular materials processing system according to claim 10, further comprising a pelletizing module, wherein the polymer composite material is treated to form a pelletized polymer composite material comprising a predetermined material load of from 1% to 50% by weight of the dispersed, exfoliated aggregate material.

15. The modular materials processing system according to claim 1, further comprising a polymer source module in fluid communication with the first pressure module, wherein the polymer source module provides a polymer for mixing with the supercritical fluid and the aggregate material in the at least one supercritical fluid processing vessel.

16. The modular materials processing system according to claim 15, wherein the polymer is a polyolefin selected from the group consisting of polyvinyl chloride (PVC), polyethylene terephthalate, polyacrylonitrite, high density polyethylene (HDPE), polyethylene terephthalate (PETE), polyethylene triphallate (PET), polycarbonate, polyolefins, polypropylene, polystyrene, low density polyethylene (LDPE), linear low density polyethylene (“LLPE”), polybutylene terephthalate, ethylene-vinyl acetate, acrylic-styrene-acrylonitrile, melamine and urea formaldehyde, polyurethane, acrylonitrile-butadiene-styrene, phenolic, polybutylene, polyester, chlorinated polyvinyl chloride, polyphenylene oxide, epoxy resins, polyacrylics, polymethyl methacrylate, acetals, acrylics, amino resins cellulosics, polyamides, phenol formaldehyde, nylon, polytetrafluoroethylene, and blends and copolymers of any thereof.

17. The modular materials processing system according to claim 16, wherein the polymer is polyethylene or polypropylene.

18. The modular materials processing system according to claim 15, wherein the collection vessel comprises an extruder that extrudes a polymer composite material comprising the polymer and the dispersed, exfoliated aggregate material.

19. The modular materials processing system according to claim 18, wherein the polymer composite material is a master batch comprising from 25% to 50% by weight of the dispersed, exfoliated aggregate material and 50% to 75% by weight of the polymer.

20. The modular materials processing system according to claim 1, wherein the modular materials processing system can be located on-site or at a manufacturing campus.

21. A modular materials processing system comprising:
a first pressure module comprising from 1 to 12 supercritical fluid processing vessels each having a mechanical mixing device capable of fluidizing an aggregate material and a supercritical fluid and forming a mixture of the supercritical fluid and the aggregate material wherein a portion of the supercritical fluid is dispersed into gallery spaces of the aggregate material, wherein the supercritical fluid processing vessels are arranged in parallel or in series;
a supercritical fluid source module in fluid communication with the first pressure module;
an aggregate material source module in fluid communication with the first pressure module;
at least one intermediate pressure release valve configured to release the mixture of the supercritical fluid and the aggregate material from the supercritical fluid processing vessels at sonic velocity and produce a depressurized supercritical fluid and a dispersed, exfoliated aggregate material;
a second module comprising at least one collection vessel configured to collect the depressurized supercritical fluid and the dispersed, exfoliated aggregate material, the collection vessel being in fluid communication with the supercritical fluid processing vessel through the intermediate pressure release valve; and
a recycling module for recycling the depressurized supercritical fluid and in fluid communication with the collection vessel and the supercritical fluid source module or the first pressure module, the recycling module comprising a compressor for repressurizing the supercritical fluid.

22. The modular materials processing system according to claim 21, further comprising a polymer source module in fluid communication with the first pressure module or the second module, wherein the polymer source module provides a polymer to the processing system.

23. The modular materials processing system according to claim 22, wherein the second module comprises a composite mixing module in fluid communication with the at least one collection vessel and wherein the polymer source module is in fluid communication with the composite mixing module of the second module,
wherein the composite mixing module is configured to mix a polymer and the dispersed, exfoliated aggregate material to produce a polymer composite material.

24. The modular materials processing system according to claim 23, further comprising a pelletizing module, wherein the polymer composite material is treated to form a pelletized polymer composite material comprising a predetermined material load of from 1% to 50% by weight of the dispersed, exfoliated aggregate material.

25. The modular materials processing system according to claim 22, wherein the polymer source module is in fluid communication with the first module, and wherein the polymer source module provides a polymer for mixing with the supercritical fluid and the aggregate material in the 1 to 12 supercritical fluid processing vessels.

26. The modular materials processing system according to claim 25, wherein the at least one collection vessel comprises an extruder that extrudes a polymer composite material comprising the polymer and the dispersed, exfoliated aggregate material.

27. The modular materials processing system according to claim 26, wherein the polymer composite material is a master batch comprising from 25% to 50% by weight of the dispersed, exfoliated aggregate material and from 50% to 75% by weight of the polymer.

28. The modular materials processing system according to claim 21, wherein the supercritical fluid is carbon dioxide; and
wherein the aggregate material is a material selected from the group consisting of a silicate clay, montmorillonite clay, smectite clay, zirconium phosphate, zeolites, talc, graphite, carbon black, carbon nanotubes, calcium carbonate, other aggregated materials, and combinations of any thereof.

29. The modular materials processing system according to claim 22, wherein the polymer is a polyolefin selected from the group consisting of polyvinyl chloride (PVC), polyethylene terephthalate, polyacrylonitrite, high density polyethylene (HDPE), polyethylene terephthalate (PETE), polyethylene triphallate (PET), polycarbonate, polyolefins, polypropylene, polystyrene, low density polyethylene (LDPE), linear low density polyethylene (“LLPE”), polybutylene terephthalate, ethylene-vinyl acetate, acrylic-styrene-acrylonitrile, melamine and urea formaldehyde, polyurethane, acrylonitrile-butadiene-styrene, phenolic, polybutylene, polyester, chlorinated polyvinyl chloride, polyphenylene oxide, epoxy resins, polyacrylics, polymethyl methacrylate, acetals, acrylics, amino resins cellulosics, polyamides, phenol formaldehyde, nylon, polytetrafluoroethylene, and blends and copolymers of any thereof.

30. The modular materials processing system according to claim 29, wherein the polymer is polyethylene or polypropylene.

31. The modular materials processing system according to claim 21, wherein the first pressure module comprises from 2 to 12 supercritical fluid processing vessels configured to release mixtures of supercritical fluid and aggregate material into the at least one collection vessel through the at least one intermediate pressure valve, wherein the release from each of the 1 to 12 supercritical fluid processing vessels are configured to release the mixtures in a timed, overlapping sequence.
